(19) United States
(12) Patent Application Publication
(10) Pub. No.: US 2014/0032345 A1
(43) Pub. Date: Jan. 30, 2014

(54) Authentication Using Transaction Codes on a Mobile Device

(71) Applicant: Cary Edward Moore, Webster, TX (US)

(72) Inventor: Cary Edward Moore, Webster, TX (US)

(73) Assignee: Bank of America Corporation, Charlotte, NC (US)

(21) Appl. No.: 13/561,431

(22) Filed: Jul. 30, 2012

(51) Int. Cl. G06Q 40/00; G06Q 20/32; G06Q 20/20

(52) U.S. Cl. 705/18; 705/44

(57) ABSTRACT

A system includes a processor and memory operable to store user account information. The processor receives a transaction message transmitted by a transaction device in a transaction environment, the transaction message comprising transaction data obtained by the transaction device from a transaction code presented by a mobile computing device of a user. The processor further accesses the user account information and determines, using the user account information and the transaction data from the transaction message, whether the user is authenticated. The processor transmits an authentication message indicating whether the user is authenticated to the transaction device.

### TECHNICAL FIELD

This disclosure relates generally to the field of financial transactions and more specifically to authentication using transaction codes on a mobile device.

### BACKGROUND

In order to conduct a financial transaction, a user may be required to present some form of identification in order to authenticate the user. For example, a user may be required to present a driver's license when attempting to make a purchase with a credit card or check. As another example, a business may compare a user's signature on the back of a credit card to the user's physical signature on a paper receipt or on a digital checkout terminal. Unfortunately, these methods are problematic and not very effective. For example, a fraudster may be able to mimic the signature on the back of a stolen credit card when it is being used to purchase goods. As another example, a busy employee of a business may neglect to adequately analyze a user's driver's license or signature when the user attempts to make a purchase with a credit card or check.

### SUMMARY OF THE DISCLOSURE

According to one embodiment, a system includes a processor and memory operable to store user account information. The processor receives a transaction message transmitted by a transaction device in a transaction environment, the transaction message including transaction data obtained by the transaction device from a transaction code presented by a mobile computing device of a user. The processor further accesses the user account information and determines, using the user account information and the transaction data from the transaction message, whether the user is authenticated. The processor transmits an authentication message indicating whether the user is authenticated to the transaction device.

Certain embodiments of the disclosure may provide one or more technical advantages. In some embodiments, a user may interact with a mobile device in order to generate a transaction code. For example, the user may enter a password or a code from a key fob in order to generate the transaction code. The transaction code may be stored on the mobile device and may include various data used to authenticate the user. This transaction code may then be presented by a user to conduct a transaction. For example, a user may cause the transaction code to be graphically displayed on a smartphone where it may be electronically scanned at the point of sale. As another example, a user may cause the transaction code to be graphically displayed on a smartphone where it may be electronically scanned at an ATM. The information from the scanned transaction code may be transmitted to a financial institution where it may be used to authenticate the user.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates an example system for providing authentication using transaction codes on a mobile device, according to certain embodiments;

FIG. 2 illustrates example transaction data that may be included in the transaction code of FIG. 1, according to certain embodiments;

FIG. 3 illustrates an example method for providing authentication using transaction codes on a mobile device, according to certain embodiments; and

FIG. 4 illustrates an example computer system that may be utilized by portions of the system of FIG. 1, according to certain embodiments.

### DETAILED DESCRIPTION OF THE DRAWINGS

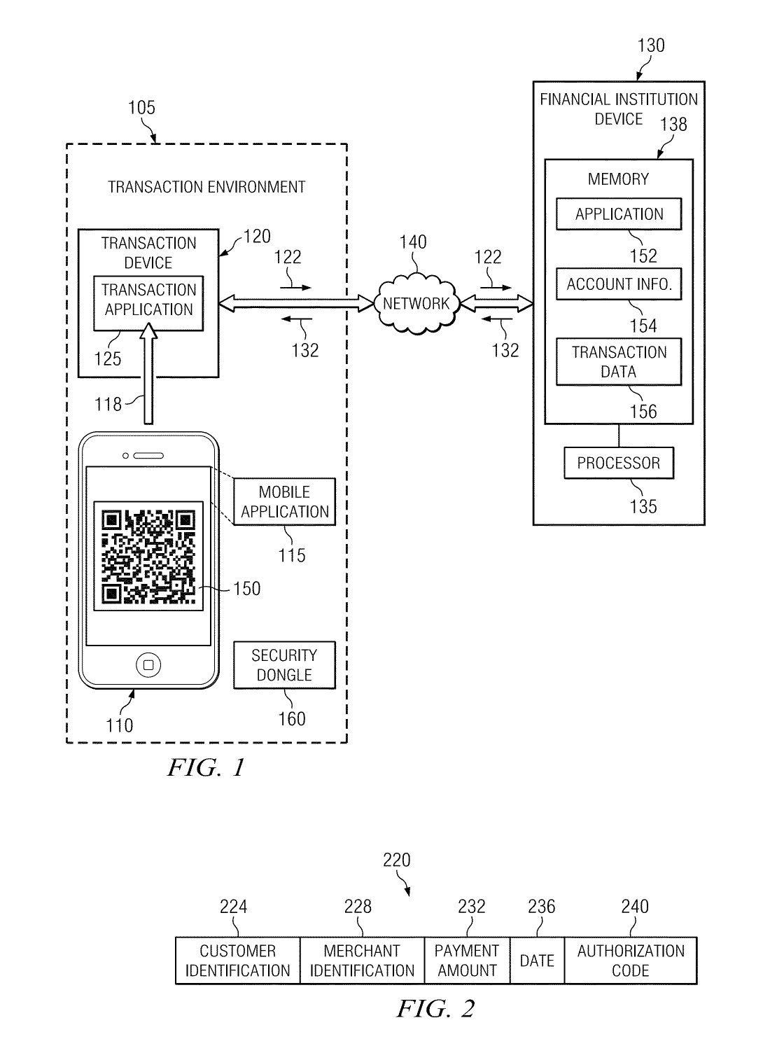

Embodiments of the present disclosure are best understood by referring to FIGS. 1 through 4 of the drawings, like numerals being used for like and corresponding parts of the various drawings.

Customers of banks and other financial institutions typically conduct many transactions using credit cards and debit cards issued by the financial institution. For example, a user may purchase products from a merchant by presenting a credit or debit card at a point-of-sale terminal. As another example, a user may visit an automated teller machine (ATM) and utilize a credit or debit card to withdraw or deposit funds.

Conducting financial transactions using credit or debit cards may require authentication of the user. In one example, a user may be asked to present a form of identification at a point-of-sale terminal before a transaction is completed. In another example, a user may be required to enter a personal identification number (PIN) into an ATM before conducting a financial transaction. However, these and other methods of authenticating a user in order to conduct a financial transaction may be inefficient, ineffective, and frustrating for users.

The teachings of the disclosure recognize that it would be desirable to provide authentication for financial transactions using transaction codes presented by a user's mobile computing device. For example, a user may cause a quick response (QR) code to be displayed on a mobile computing device. This QR code may be scanned by a transaction device and transmitted to a financial institution where it may be used to authenticate the user. FIGS. 1 through 4 below illustrate a system and method for providing authentication using transaction codes on a mobile device according to the teachings of the disclosure.

FIG. 1 illustrates a system 100 for providing authentication using transaction codes on a mobile device. System 100 includes a transaction environment 105, a mobile computing device 110, a transaction device 120, and a financial institution device 130. Financial institution device 130 and financial institution device 130 are communicatively coupled via a network 140. Financial institution device 130 provides authentication for a user associated with mobile computing device 110 using a transaction code 150 presented by mobile computing device 110.

In general, a user interacts with mobile computing device 110 in order to present transaction code 150 when conducting a financial transaction. For example, a user may display transaction code 150 to transaction device 120 when attempting to purchase items. As another example, a user may transmit transaction code 150 to transaction device 120 when attempting to withdraw or deposit funds. Transaction device 120 utilizes a reception method 118 to receive the transaction code 150 presented by mobile computing device 110 and transmit a transaction message 122 to financial institution device 130. Transaction message 122 includes transaction data that was obtained at least in part from transaction code 150. Financial institution device 130 receives transaction message 122 and utilizes it and possibly user account information 154 to authenticate the user who is attempting to conduct the financial transaction. Financial institution device 130 then transmits authentication message 132 back to transaction device 120 where it is used to approve or decline the transaction. Details of the components of system 100 are discussed in more detail below.

Transaction environment 105 represents any suitable components that allow users to perform financial transactions. According to the illustrated embodiment, transaction environment 105 includes transaction device 120 and mobile computing device 110. Transaction device 120 represents any suitable components that verify and process a financial transaction. Transaction device 120 may include a cash register, a vending machine, a point-of-sale terminal, a personal computer, a workstation, a laptop, a wireless or cellular telephone, an electronic notebook, a personal digital assistant, an ATM, a terminal in a banking center, or any other device (wireless, wireline, or otherwise) capable of receiving, processing, storing, and/or communicating information with other components of system 100 in order to input, verify, and process a financial transaction. Transaction device 120 may comprise a user interface, such as a display, a microphone, keypad, credit/debit card terminal, a scanner (such as a barcode scanner), or other appropriate terminal equipment usable by a user.

In some embodiments, transaction device 120 may include a network server, any suitable remote server, a mainframe, a host computer, a workstation, a web server, a personal computer, a file server, or any other suitable device operable to conduct financial transactions. The functions of transaction device 120 may be performed by any suitable combination of one or more servers or other components at one or more locations. In some embodiments, transaction device 120 may be a private server, and the server may be a virtual or physical server. The server may include one or more servers at the same or remote locations. Transaction device 120 may include any suitable component that functions as a server. In certain embodiments, transaction device 120 may be implemented using computer system 400 discussed further below in reference to FIG. 4.

Reception method 118 may represent any method for receiving transaction code 150. For example, reception method 118 may represent transaction device 120 scanning transaction code 150 displayed on mobile computing device 110 using a scanner. In such embodiments, transaction code 150 may be an image in the form of a linear barcode, matrix barcode, a sequence of numbers and/or symbols, any other suitable image, or any combination of the preceding. As another example, reception method 118 may represent transaction device 120 receiving transaction code 150 based on radio frequencies, such as frequencies associated with near field communications (NFC), radio frequency identification (RFID), Bluetooth, and the like. In such embodiments, a user may simply place mobile computing device 110 in close proximity to transaction device 120 in order for transaction device 120 to receive transaction code 150 using reception method 118 (e.g., with a transceiver of transaction device 120).

Transaction device 120 also may include a transaction application 125. Transaction application 125 represents any suitable software or logic that allows transaction device 120 to input, verify, and process a financial transaction. Transaction application 125 further represents any suitable software or logic that allows transaction information to be generated and communicated to financial institution device 130. Transaction application 125 further allows transaction code 150 to be received from mobile computing device 110.

Mobile computing device 110 may be any device that is capable of presenting transaction code 150. In some embodiments, mobile computing device 110 may be a mobile telephone, a smartphone, a laptop computer, a digital audio player, a tablet computer, and the like. Mobile computing device 110 may include memory that is capable of storing mobile application 115. Mobile application 115 is discussed further below. In certain embodiments, mobile computing device 110 may be implemented using computer system 400 discussed further below in reference to FIG. 4.

Mobile application 115 generally refers to logic, rules, algorithms, code, tables, and/or other suitable instructions for performing the described functions and operations for mobile computing device 110. For example, mobile application 115 may allow a user to interact with mobile computing device 110 in order to input information that may be used to authenticate the user. The information may include a password, an authorization code from a key fob such as security dongle 160, or any other information used to identify the user. Mobile application 115 accesses any information input by the user in order to generate transaction code 150. In some embodiments, mobile application 115 causes transaction code 150 to be displayed on mobile computing device 110. In some embodiments, mobile application 115 causes transaction code 150 to be transmitted from mobile computing device 110 via, for example, Bluetooth, Wi-Fi, RFID, or any other appropriate method.

Financial institution device 130 represents any suitable computing system or systems associated with a financial institution that facilitate transactions between users and merchants. Financial institution device 130 may include a network server, any suitable remote server, a mainframe, a host computer, a workstation, a web server, a personal computer, a file server, or any other suitable device operable to facilitate transactions between users and merchants. The functions of financial institution device 130 may be performed by any suitable combination of one or more servers or other components at one or more locations. In embodiments where the financial institution device 130 is a server, the server may be a private server, and the server may be a virtual or physical server. The server may include one or more servers at the same or remote locations. Financial institution device 130 may include any suitable component that functions as a server. In the illustrated embodiment, financial institution device 130 includes a processor 135 and a memory 138. Financial institution device 130 may be implemented using computer system 400 discussed further below in reference to FIG. 4.

Memory 138 may refer to any suitable device(s) capable of storing and facilitating retrieval of data and/or instructions. Examples of memory 138 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile computer-readable memory devices that store one or more files, lists, tables, or other arrangements of information. Although FIG. 1 illustrates memory 138 as internal to financial institution device 130, it should be understood that memory 138 may be internal or external to financial institution device 130, depending on particular implementations. Also, memory 138 may be separate from or integral to other memory devices to achieve any suitable arrangement of memory devices for use in system 100. Particular embodiments of memory 138 are discussed further below in reference to FIG. 4.

Memory 138 is generally operable to store a management application 152, user account information 154, and transaction data 156. Management application 152 generally refers to logic, rules, algorithms, code, tables, and/or other suitable instructions for performing the described functions and operations. Transaction data 156 may be any information obtained from or generated from transaction message 122. A particular embodiment of transaction data 156 is described in more detail below in reference to FIG. 2. User account information 154 may include any data regarding one or more user accounts of the financial institution associated with financial institution device 130.

Memory 138 is communicatively coupled to processor 135. Processor 135 is generally operable to execute management application 152 stored in memory 138 to provide authentication of a user using transaction code 150 presented by mobile computing device 110, according to the disclosure. Processor 135 may comprise any suitable combination of hardware and software implemented in one or more modules to execute instructions and manipulate data to perform the described functions for financial institution device 130. In some embodiments, processor 135 may include, for example, any type of central processing unit (CPU), a programmable logic device, a microcontroller, a microprocessor, any suitable processing device, or any suitable combination of the preceding. Particular embodiments of processor 135 are discussed further below in reference to FIG. 4.

In certain embodiments, network 140 may refer to any interconnecting system capable of transmitting audio, video, signals, data, messages, or any combination of the preceding. Network 140 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

Transaction code 150 may be any type of code that may be used to conduct transactions. For example, transaction code 150 may be a code that is visually displayed on a display of mobile computing device 110 in the form of a linear bar code (or a one dimensional bar code), such as a code 93, a code 128, or a universal product code (UPC); or a matrix bar code (or a two dimensional bar code), such as a QR code, a MaxiCode, or a ShotCode. In some embodiments, transaction code 150 is a code that may be transmitted through radio frequencies, such as a code that may be transmitted using NFC, RFID, Bluetooth, Wi-Fi, or any other method. In some embodiments, transaction code 150 is a sequence of numbers and/or symbols; any other transaction code; or any combination of the preceding. Transaction code 150 may include any information that allows a transaction to be performed. The information included in the transaction code is discussed further below in reference to FIG. 2.

Security dongle 160 may be any device that is capable of providing an authorization code to be used to authenticate a financial transaction. In some embodiments, security dongle 160 is a key fob or a security token that displays an authorization code. In certain embodiments, the authorization code may be any combination of numbers or letters that may be entered into mobile computing device 110. The authorization code may be captured and embedded within transaction code 150 by, for example, mobile application 115 running on mobile computing device 110.

FIG. 2 illustrates example transaction data 220 that may be included in transaction code 150 and used to conduct a financial transaction. In particular embodiments, transaction data 220 may be an example of transaction data 156 from transaction code 150 that is provided to financial institution device 130 in transaction message 122. In some embodiments, transaction data 220 includes one or more of a user identification 224, a merchant identification 228, a payment amount 232, a date 236, and an authorization code 240.

User identification 224 represents any data that may identify a particular user. For example, user identification 224 may include the user's name, the user's address, the user's social security number, an online identifier associated with the user, an account number associated with the user, any other information that identifies the user, or any combination of the preceding. In particular embodiments, financial institution device 130 may utilize user identification 224 in order to determine which user is associated with transaction message 122. For example, management application 152 of financial institution device 130 may look for user identification 224 in user account in order to determine whether the user is a user of the bank, particular account information of the user, and the like.

Merchant identification 228 represents any data that may identify a merchant with whom the user desires to conduct a transaction. For example, merchant identification 228 may include the merchant's name, the merchant's address, an identifier associated with the merchant, any other data that identifies the merchant, or any combination of the preceding. In particular embodiments, financial institution device 130 may utilize merchant identification 228 in order to determine the merchant with whom the user desires to conduct a transaction. In particular embodiments, merchant identification 228 may assist financial institution device 130 in determining whether or not to approve the transaction. For example, financial institution device 130 may use merchant identification 228 to determine that the merchant is no longer in good standing with the financial institution, or to determine that the merchant has not signed up for this service with the financial institution. As such, financial institution device 130 may determine not to approve the transaction.

Payment amount 232 represents any data that may identify an amount of money that is needed to conduct the financial transaction of the user. For example, payment amount 232 may include any suitable amount of money, such as $1, $10, $100, $1,000, or any other appropriate amount. Date 236 represents any data that may identify a date and/or time associated with the financial transaction.

Authorization code 240 represents any appropriate information entered into mobile computing device 110 by the user for authentication. As one example, authorization code 240 may be a password and/or PIN entered into mobile computing device 110 by the user. As another example, authorization code 240 may be any combination of numbers or letters displayed on security dongle 160 and subsequently entered into mobile computing device 110 by the user. Authorization code 240 may be used by financial institution device 130 to authenticate the user. For example, financial institution device 130 may compare authorization code 240 with information in user account information 154 to determine if, for example, the user has entered a correct password. As another example, financial institution device 130 may compare authorization code 240 from security dongle 160 with a synchronous code generated by financial institution device 130 to authenticate the user.

In particular embodiments, transaction data 220 may include any other information. For example, transaction data 220 may include a unique identifier that prevents transaction data 220 from being used multiple times, a time period for which transaction data 220 is valid, or any other information.

Transaction data 220 may be in any type of form. For example, transaction data 220 may be in the form of an image, such as a linear bar code (e.g., a code 93, a code 28, or a UPC), a matrix bar code (e.g., a QR code, a MaxiCode, or a ShotCode), a sequence of numbers and/or symbols, any other image, or any combination of the preceding. As another example, transaction data 220 may be in the form of a communication that may be transmitted according to frequencies associated with, for example, NFC or RFID.

In an exemplary embodiment of operation with respect to FIGS. 1 and 2, a user may desire to conduct a financial transaction with, for example, a merchant, an ATM, or a bank. In order to do so, the user may interact with mobile application 115 on mobile computing device 110 and input authorization code 240. For example, the user may input a password or PIN into a graphical user interface (GUI) displayed on mobile computing device 110 by mobile application 115. As another example, the user may obtain authorization code 240 from security dongle 160 and input authorization code 240 into a GUI on mobile computing device 110.

After a user has input authorization code 240 into mobile computing device 110, mobile application 115 generates transaction code 150. In certain embodiments, authorization code 240 is embedded within transaction code 150. In some embodiments, other information such as user identification 224 is embedded within transaction code 150. After transaction code 150 has been generated by mobile application 115, it may be stored in memory of mobile computing device 110.

In some embodiments, a user may input other information into mobile computing device 110 in order to conduct a financial transaction. For example, the user may interact with mobile application 115 in order to indicate details of a desired financial transaction. As a specific example, the user may indicate in a GUI of mobile application 115 that he wishes to withdraw or deposit a certain amount of money. This and any other information associated with a desired financial transaction may also be embedded within transaction code 150 by mobile application 115.

When a user wishes to conduct the financial transaction, the user may interact with mobile application 115 in order to present transaction code 150 to transaction device 120 using mobile computing device 110. In certain embodiments, the user causes transaction code 150 to be displayed on a display of mobile computing device 110 as, for example, a QR code or any other appropriate code as discussed above. In certain embodiments, the user causes transaction code 150 to be transmitted from mobile computing device 110 using, for example, RFID, NFC, Bluetooth, Wi-Fi, or any other radio-based communications method. In one embodiment, the user simply waves or otherwise places mobile computing device 110 within close proximity to transaction device 120.

Transaction device 120 utilizes reception method 118 as described above to receive transaction code 150. For example, transaction device 120 utilizes a scanner to scan transaction code 150 as it is being graphically displayed on mobile computing device 110. As another example, transaction device 120 utilizes a transceiver to receive transaction code 150 as it is transmitted from mobile computing device 110.

After receiving transaction code 150 from mobile computing device 110, transaction device 120 generates transaction message 122 and transmits it for receipt by financial institution device 130. In some embodiments, transaction message 122 includes information from transaction code 150 such as, for example, authorization code 240 and/or user identification 224. In certain embodiments, transaction message 122 includes other information associated with the financial transaction such as, for example, merchant identification 228, payment amount 232, and date 236. In certain embodiments, transaction message 122 includes information associated with a desired financial transaction such as, for example, an amount of money to withdraw or deposit.

Financial institution device 130 receives transaction message 122 and analyzes transaction data 156 included within transaction message 122 in order to authenticate the user and/or the financial transaction. In certain embodiments, financial institution device 130 may compare authorization code 240 and/or user identification 224 with user account information 154 in order to authenticate the user. In certain embodiments, financial institution device 130 may compare authorization code 240 from security dongle 160 with a synchronous code generated by financial institution device 130 in order to authenticate the user. In some embodiments, financial institution device 130 may compare payment amount 232 with information from user account information 154 to determine whether the user has sufficient funds for the transaction. The disclosure anticipates any appropriate method of authenticating the user using transaction data 156 from transaction code 150.

Financial institution device 130 generates and transmits authentication message 132 for receipt by transaction device 120 after attempting to authenticate the user. Authentication message 132 indicates that the user is not authenticated if financial institution device 130 was unable to authenticate the user. For example, if a password supplied by the user and included in transaction code 150 as authorization code 240 does not match a stored password of the user in user account information 154, the user may not be authenticated. In another example, if an authorization code 240 obtained from security dongle 160 does not match a synchronous code generated by financial institution device 130, the user may not be authenticated. On the other hand, if the user is authenticated, authentication message 132 indicates that the user has been successfully authenticated.

Transaction device 120 receives authentication message 132 and performs one or more actions according to information in authentication message 132. For example, if authentication message 132 indicates that the user has been authenticated, a financial transaction may be completed or approved. If, however, authentication message 132 indicates that the user has not been authenticated, a financial transaction may be denied. For example, a merchant may complete a sale of merchandise at a point-of-sale terminal if authentication message 132 indicates that the user is authenticated. On the other hand, if authentication message 132 indicates that the user has not been authenticated, the merchant may not complete the financial transaction.

As an example for illustrative purposes only, consider a scenario where a user wishes to purchase a television from a merchant. The user may take the television to a point-of-sale terminal of the merchant and attempt to check out. The user may launch mobile application 115 on mobile computing device 110 and enter a password or an authorization code 240 from security dongle 160. Mobile application 115 may then generate transaction code 150 using the information entered by the user and cause the transaction code 150 to be displayed on mobile computing device 110.

The merchant may utilize the point-of-sale terminal to scan a barcode of the television and transaction code 150 displayed on mobile computing device 110. Using the scanned information, the point-of-sale terminal generates a transaction message 122 that contains information about the sale and information from transaction code 150. The point-of-sale terminal transmits transaction message 122 to financial institution device 130 where it is received and processed by management application 152. Management application 152 accesses user account information 154 and utilizes information in user account information 154 and transaction message 122 in order to authenticate the user as described above. Financial institution device 130 then transmits authentication message 132 back to the point-of-sale terminal. The point-of-sale terminal receives authentication message 132 and either approves or denies the financial transaction according to whether or not authentication message 132 indicates that the user is authenticated.

As another example for illustrative purposes, consider a scenario where a user wishes to withdraw money from an ATM. The user may interact with mobile application 115 in order to indicate details about the desired financial transaction with the ATM. For example, the user may indicate to mobile application 115 that he wishes to withdraw $100. The user may also interact with mobile application 115 in order to enter authorization code 240 as described above. Mobile application 115 compiles all of this information and generates transaction code 150. The user then approaches the ATM and waves mobile computing device 110 at or otherwise places mobile computing device 110 in close proximity to the ATM. The transaction code 150 is transmitted wirelessly by mobile computing device 110 and received by the ATM. The ATM generates transaction message 122 using information from transaction code 150 and transmits transaction message 122 to financial institution device 130 for authentication. Financial institution device 130 receives transaction message 122, authenticates the user as described above, and transmits authentication message 132 back to the ATM. The ATM receives authentication message 132 and approves or denies the transaction. For example, if the user is authenticated, the ATM dispenses the desired $100 to the user. As a result, the user may be able to more quickly and efficiently interact with the ATM.

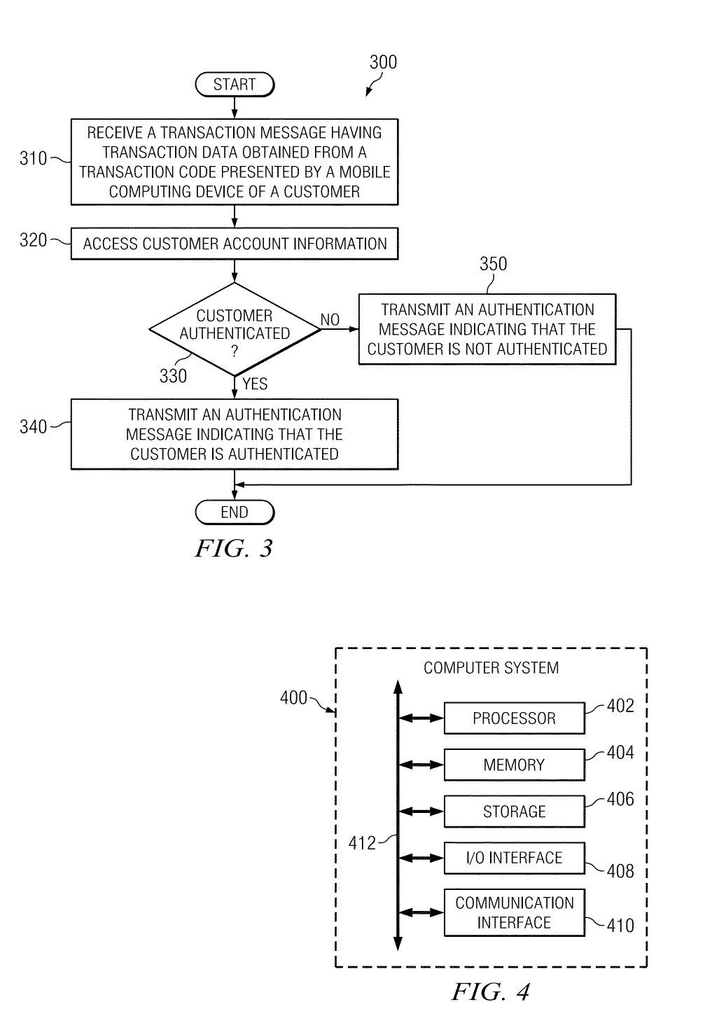

FIG. 3 illustrates an example method for providing authentication using transaction codes on a mobile device. In particular embodiments, one or more steps of method 300 may be performed by financial institution device 130, transaction device 120, mobile computing device 110, and/or any combination of the preceding.

Method 300 begins in step 310 where a transaction message is received. In certain embodiments, the transaction message is transaction message 122 above. In some embodiments, the transaction message is received at financial institution device 130. In certain embodiments, the transaction message has transaction data such as transaction data 156 that was obtained from a transaction code presented by a mobile device. In some embodiments, the transaction code may refer to transaction code 150 discussed above and the mobile device may be mobile computing device 110 discussed above.

The transaction message of step 310 may be generated by a transaction device, such as transaction device 120 described above, using information from a transaction code. A user may interact with a mobile device such as mobile computing device 110 above in order to generate and present the transaction code to the transaction device. The transaction device may utilize any appropriate method described above to receive the transaction code from the mobile device.

In step 320, user account information is accessed. In some embodiments, the user account information is user account information 154 discussed above. In certain embodiments, the user account information is accessed by financial institution device 130 discussed above.

In step 330, the user is authenticated. In some embodiments, this involves utilizing the user account information of step 320 and the transaction data from step 310. In certain embodiments, step 320 includes determining whether a password or PIN entered by a user into a mobile device matches a stored password or PIN of the user in the user account information. In certain embodiments, step 320 includes determining whether the user has entered a correct authorization code from a key fob into the mobile device. In some embodiments, step 320 includes determining whether the user has sufficient funds for a financial transaction.

If the user is authenticated successfully in step 330, method 300 proceeds to step 340. Otherwise, method 300 proceeds to step 350. In step 340, an authentication message is transmitted to the transaction device indicating that the user has been successfully authenticated. In step 350, an authentication message is transmitted to the transaction device indicating that the user has not been successfully authenticated. In certain embodiments, the authentication message is authentication message 132 discussed above. After steps 340 and 350, method 300 ends.

FIG. 4 illustrates an example computer system 400 that may be one or more portions of mobile computing device 110, transaction device 120, and/or financial institution device 130 described above. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 400 may include one or more computer systems 400; be unitary or distributed; span multiple locations; span multiple machines; span multiple datacenters; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. Although this disclosure describes and illustrates particular memory, this disclosure contemplates any suitable memory.

In particular embodiments, storage 406 includes mass storage for data or instructions. Storage 406 may include removable or non-removable (i.e., fixed) media, where appropriate. Storage 406 may be internal or external to computer system 400, where appropriate. In particular embodiments, storage 406 is non-volatile, solid-state memory. Where appropriate, storage 406 may include one or more storages 406. Although this disclosure describes and illustrates particular storage, this disclosure contemplates any suitable storage.

In particular embodiments, I/O interface 408 includes hardware, software, or both providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a Wi-Fi network. This disclosure contemplates any suitable network and any suitable communication interface 410 for it. Although this disclosure describes and illustrates a particular communication interface, this disclosure contemplates any suitable communication interface.

In particular embodiments, bus 412 includes hardware, software, or both coupling components of computer system 400 to each other. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A system comprising:
a memory operable to store user account information; and
a processor communicatively coupled to the memory, the processor operable to:
receive a transaction message transmitted by a transaction device in a transaction environment, the transaction message comprising transaction data obtained by the transaction device from a transaction code presented by a mobile computing device of a user;
access the user account information;
determine, using the user account information and the transaction data from the transaction message, whether the user is authenticated; and
transmit an authentication message for receipt by the transaction device, the authentication message indicating whether the user is authenticated.

2. The system of claim 1, further comprising a mobile application for execution on the mobile computing device of the user, the mobile application operable, upon execution, to:
generate the transaction code; and
present the transaction code using the mobile computing device.

3. The system of claim 1, further comprising a transaction application for execution on the transaction device, the transaction application operable, upon execution, to:
scan for the transaction code presented by the mobile computing device in order to receive the transaction code;
generate the transaction message;
transmit the transaction message;
receive the authentication message; and
perform one or more actions according to the authentication message.

4. The system of claim 3, wherein the one or more actions is selected from the group consisting of:
completing a transaction with the user;
declining to complete a transaction with the user;
dispense an amount of money to the user; and
declining to dispense an amount of money to the user.

5. The system of claim 1, wherein the mobile computing device is selected from the group consisting of:
a mobile telephone;
a smartphone;
a laptop computer;
a digital audio player; and
a tablet computer.

6. The system of claim 1, wherein the transaction code is displayed as an image selected from a group consisting of:
a Code 93;
a Code 128;
a Universal Product Code (UPC);
a Quick Response (QR) code;
a MaxiCode; and
a ShotCode.

7. The system of claim 1, wherein the transaction code comprises an identification of the user and a security token.

8. The system of claim 1, wherein the transaction device is selected from the group consisting of a point-of-sale terminal, an automated teller machine (ATM), and a banking center terminal.

9. One or more non-transitory computer readable media comprising logic, the logic, when executed by a processor, operable to:
receive a transaction message transmitted by a transaction device in a transaction environment, the transaction message comprising transaction data obtained by the transaction device from a transaction code presented by a mobile computing device of a user;
access user account information;
determine, using the user account information and the transaction data from the transaction message, whether the user is authenticated; and
transmit an authentication message for receipt by the transaction device, the authentication message indicating whether the user is authenticated.

10. The logic of claim 9, wherein the transaction code is displayed as an image selected from a group consisting of:
a Code 93;
a Code 128;
a Universal Product Code (UPC);
a Quick Response (QR) code;
a MaxiCode; and
a ShotCode.

11. The logic of claim 9, wherein the transaction device is selected from the group consisting of a point-of-sale terminal, an automated teller machine (ATM), and a banking center terminal.

12. A method, comprising:
receiving, by one or more computing systems, a transaction message transmitted by a transaction device in a transaction environment, the transaction message comprising transaction data obtained by the transaction device from a transaction code presented by a mobile computing device of a user;
accessing, by the one or more computing systems, user account information;
determining, by the one or more computing systems using the user account information and the transaction data from the transaction message, whether the user is authenticated; and
transmitting an authentication message for receipt by the transaction device, the authentication message indicating whether the user is authenticated.

13. The method of claim 12, further comprising:
generating, by a mobile application on the mobile computing device of the user, the transaction code; and
presenting the transaction code by the mobile computing device.

14. The method of claim 12, further comprising:
scanning, by a transaction application on the transaction device, the transaction code presented by the mobile computing device in order to receive the transaction code;
generating, by the transaction application, the transaction message;
transmitting, by the transaction application, the transaction message;
receiving, by the transaction application, the authentication message; and
performing, by the transaction application, one or more actions according to the authentication message.

15. The method of claim 14, wherein the one or more actions is selected from the group consisting of:
completing a transaction with the user;
declining to complete a transaction with the user;
dispense an amount of money to the user; and
declining to dispense an amount of money to the user.

16. The method of claim 12, wherein the mobile computing device is selected from the group consisting of:
a mobile telephone;
a smartphone;
a laptop computer;
a digital audio player; and
a tablet computer.

17. The method of claim 12, wherein the transaction code is displayed as an image selected from a group consisting of:
a Code 93;
a Code 128;
a Universal Product Code (UPC);
a Quick Response (QR) code;
a MaxiCode; and
a ShotCode.

18. The method of claim 12, wherein the transaction code comprises an identification of the user and a security token.

19. The method of claim 12, wherein the transaction device is selected from the group consisting of a point-of-sale terminal, an automated teller machine (ATM), and a banking center terminal.

20. The method of claim 13, wherein the transaction code comprises information obtained from a security dongle.
